(19) United States
(12) Patent Application Publication
(10) Pub. No.: US 2023/0234194 A1
(43) Pub. Date: Jul. 27, 2023

(54) ONE-PIECE TOOL LATCH STRUCTURE

(71) Applicant: Chih-Chien HSIEH, Taichung City (TW)

(72) Inventor: Chih-Chien HSIEH, Taichung City (TW)

(21) Appl. No.: 17/581,264

(22) Filed: Jan. 21, 2022

(51) Int. Cl. B25B 23/00

(52) U.S. Cl. CPC B25B 23/0035; B25H 3/003

(57) ABSTRACT

A one-piece tool latch structure for positioning and setting a sleeve, which includes a socket post, wherein one end of the socket post in the axial direction is an insertion end, and the other end is a stud end. Two first faces, two second faces, two third faces, and two fourth faces are formed between the insertion end and the stud end. Each of the first faces is protruded with a positioning convex portion, and two convex ridges are respectively formed between the adjacent first face and the second face.

### CROSS-REFERENCE TO RELATED U.S. APPLICATIONS

Not applicable.

### BACKGROUND OF THE INVENTION

### 1. Field of the Invention

The present invention relates generally to an object for positioning tools, and more particularly to a one-piece tool latch structure for configuration of sleeves.

### 2. Description of Related Art Including Information Disclosed Under 37 CFR 1.97 and 37 CFR 1.98

A sleeve is a tool to sheathe a bolt or a nut, used to facilitate a sleeve spanner to drive the bolt or nut to rotate. The sleeve has a square casing groove. The periphery of the casing groove is formed with four groove walls and four edges, respectively located between each of the groove walls, and in the shape of a concave arc. Each of the groove walls is respectively provided with positioning concave cambers in the shape of a concave arc.

U.S. Pat. No. 8,499,935B2 has disclosed a fixed seat tool. Said fixed seat tool is provided for placement of the sleeve by sheathing. It can position the sleeve by means of rotation and locking, so as to facilitate storage and transportation of sleeves.

The fixed seat tool includes a sleeve socket post. The sleeve socket post is made of plastic or other elastic materials to match the four groove walls of the casing groove. The sleeve socket post is roughly shaped as an octagonal column. One end of the sleeve socket post is top end, and the other end is stud end. The top end and the stud end are opposite each other along the the axial direction of the sleeve socket post. The lateral circumference of the sleeve socket post is formed with a circumference side part. The circumference side part is located between the top end and the stud end. The circumference side part includes eight abutment surfaces and eight convex corners respectively formed between each of the abutment surfaces. When the sleeve is placed on the fixed seat tool, the sleeve sheathes the sleeve socket post through the casing groove. The top end and the circumference side part relatively enter the casing groove, and four abutment surfaces of each of the abutment surfaces are respectively adjacent to each of the groove walls, while the other four abutment surfaces respectively faces each of the connecting edges. When rotating the sleeve to change each of the abutment surfaces adjacent to each of the groove walls, part of the convex corners can be abutted on each of the groove walls and slide along each of the groove walls. There is relative friction between the convex corner and the groove wall. When the convex corner is sliding along the groove wall, the friction force will firstly increase and then decrease. Through the sleeve, the change of the friction force will be reflected to the hand of the user who is clamping and turning the sleeve. Based on the feeling, the user can judge if the abutment surface is abutting the groove wall. Such a feeling of the change of the friction force is usually called operational hand feel.

One positioning convex portion is configured on an abutment surface. As the positioning convex portion is protruded on the corresponding positioning concave camber, the sleeve cannot fall apart from the sleeve socket post along the axial direction of the sleeve socket post, so that the sleeve can be locked and positioned on the sleeve socket post.

To match the relative space configuration of each of the groove walls, each of the abutment surfaces is arranged in an octagonal array, so that an included angle of 135° is formed between each adjacent abutment surfaces of each of the convex corners. For the abutment surface to tightly abut on the groove wall, the distance between the two abutment surfaces on the two ends of the circumference side part in the radial direction shall match the distance between the two groove walls on the two sides of the casing groove in the radial direction. When the sleeve is placed on the sleeve socket post, the sleeve can be fitted on the sleeve socket post tightly and will not get loose. Due to this, when the sleeve sheathes the sleeve socket post, the part of the circumference side part adjacent to the top end cannot enter the casing groove easily. Therefore, an improvement is required to enhance the convenience of operation.

### BRIEF SUMMARY OF THE INVENTION

The main object of the present invention is to provide a one-piece tool latch structure.

Based on the above object, the technical feature of the present invention designed to solve the aforementioned problems is that the one-piece tool latch structure is provided for positioning and setting a sleeve. The sleeve has a square casing groove. The casing groove is extended at one end of the sleeve in the axial direction. To sheathe the insertion post of a ratchet tool, the periphery of the casing groove is formed with four groove walls and connecting edges in the shape of a concave arc respectively located between each of the groove walls. The distance between each of them to each of the opposite groove walls is defined as groove width W. Each of the groove walls is respective configured with positioning dents in the shape of a concave arc.

The one-piece tool latch structure includes a socket post, wherein the socket post is made of an elastic material. One end of the socket post in the axial direction is an insertion end, and the other end is a stud end. Two first faces, two second faces, two third faces and two fourth faces are formed between the insertion end and the stud end. Each of the first faces, each of the second faces, each of the third faces and each of the fourth faces are distributed in a ring array. A virtual central axis Y is defined to go along the axial direction of the socket post and through the insertion end. Each of the first faces are opposite each other with the central axis Y as the center. Each of the second faces is respectively located at one side of each of the first faces. The second faces are respectively opposite each other with the central axis as the center. Each of the third faces is respectively located at the other side of each of the first faces. The third faces are opposite each other with the central axis as the center. The fourth faces are opposite each other with the central axis as the center. Each of the second faces is respectively located at one side of each of the fourth faces. Each of the third faces is respectively located at the other side of each of the fourth faces.

The socket post goes through the through groove from the lateral direction. The through groove is located between each of the first faces, so that each of the first faces and each of the second faces can have relative elastic deformations.

Each of the first faces is respectively protruded with a positioning convex portion in the direction away from the central axis Y, so that each of the positioning convex portions can enter the corresponding positioning dent to relatively limit and position the sleeve. A virtual first inscribed circle is defined to be tangential to each of the first faces. The diameter of the first inscribed circle is a first diameter. The first diameter matches the groove width W, so that each of the first faces respectively adjacent to each of the corresponding groove walls. A virtual second inscribed circle is defined to be tangential to each of the second faces and each of the third faces. The diameter of the second inscribed circle is a second diameter. The central axis Y passes through the centers of the first inscribed circle and the second inscribed circle. The second diameter is less than the first diameter. The distance between each of the second faces and the third faces is less than the groove width W, so that the socket post an easily enter the casing groove, and the sleeve can sheathe the socket post more conveniently.

Two convex ridges are respectively formed between the adjacent first faces and the second faces. Each of the humps is respectively protruded in the direction away from the central axis Y. Each of the humps is respectively adjacent to each of the positioning convex portions, arranged in the direction parallel to the central axis Y, one end of each of the humps is located between each of the positioning convex portions and the insertion end, and the other end of each of the humps is respectively extended toward the stud end.

The main efficacy and advantage of the present invention is that the socket post can enter the casing groove more easily, and the operation can be more convenient.

### BRIEF DESCRIPTION OF THE SEVERAL VIEWS OF THE DRAWINGS

FIG. 1 is a sectional view of the sleeve in the radial direction, showing the section of the casing groove.

FIG. 2 is a perspective view of a preferred embodiment of the invention.

FIG. 3 is a top view (I) of a preferred embodiment of the invention.

FIG. 4 is a top view (II) of a preferred embodiment of the invention.

FIG. 5 is a front view of a preferred embodiment of the invention.

FIG. 6 is a 6-6 sectional view of FIG. 5.

FIG. 7 is a sectional view (I) of the sleeve configured in a preferred embodiment of the invention.

FIG. 8 is a sectional view (II) of the sleeve configured in a preferred embodiment of the invention.

FIG. 9 is a sectional view (III) of the sleeve configured in a preferred embodiment of the invention.

### DETAILED DESCRIPTION OF THE INVENTION

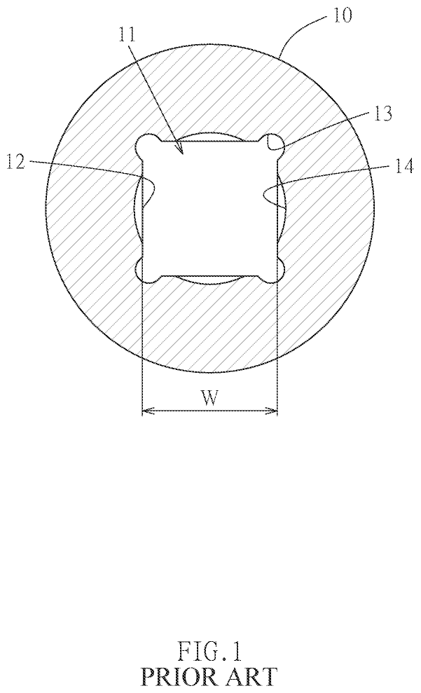

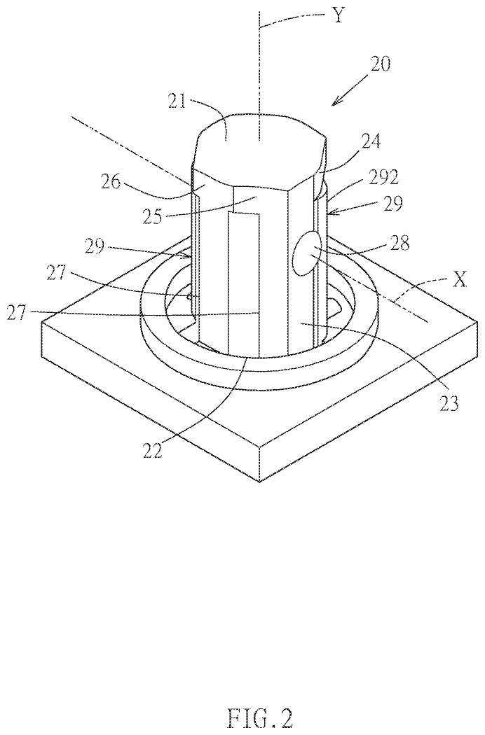

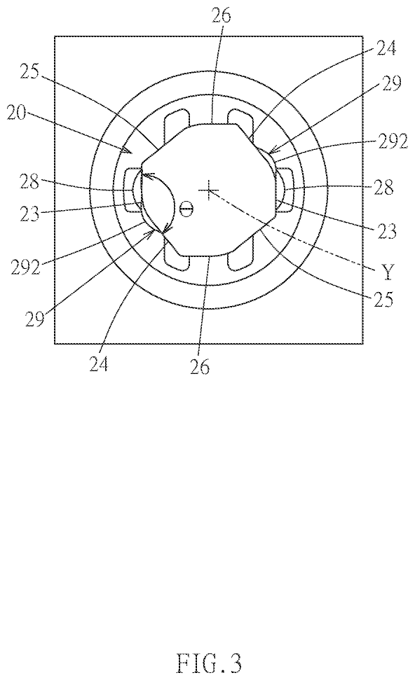

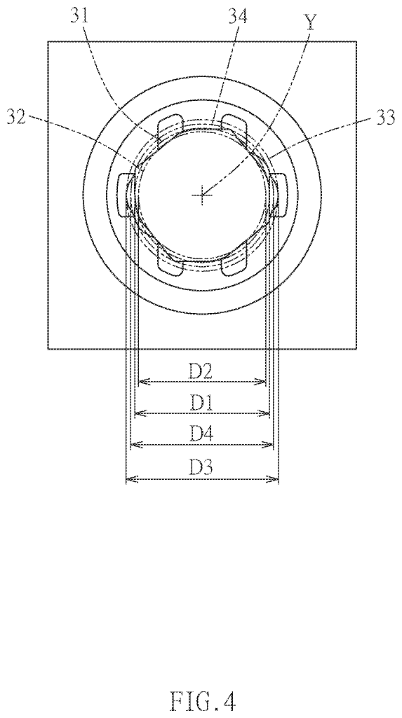

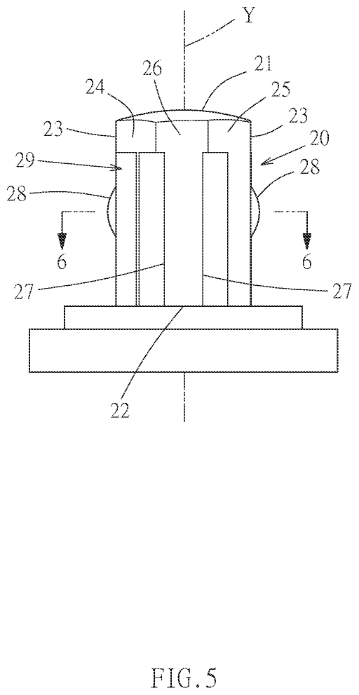

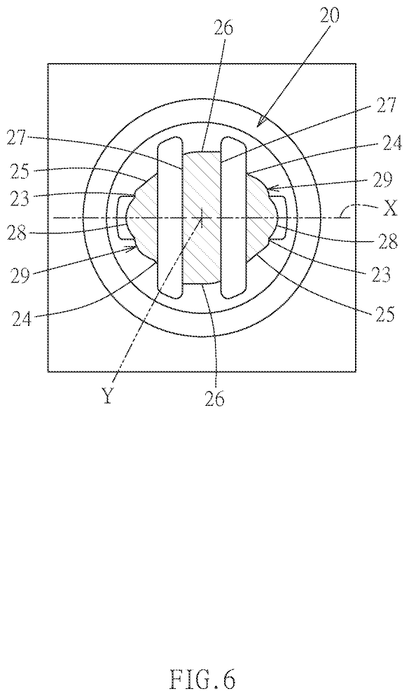

Referring to FIG. 1 to FIG. 9, the one-piece tool latch structure is used for positioning and setting a sleeve 10. The sleeve 10 has a square casing groove 11. The casing groove 11 is extended on one end of the sleeve 10 in the axial direction, to sheathe the insertion post of a ratchet tool (not shown in the figure). The ratchet tool can drive the sleeve 10 to rotate for fastening or removing such components as bolts or nuts. The periphery of the casing groove 11 is formed with four groove walls 12 and connecting edges 13 in the shape of a concave arc respectively located between each of the groove walls 12. The distance between each of the opposite groove walls 12 is defined as groove width W. Each of the groove walls 12 is provided with a positioning dent 14 in the shape of a concave arc.

A preferred embodiment of the invention includes a socket post 20. Specifically, the socket post 20 is made of an elastic material. One end of the socket post 20 in the axial direction is an insertion end 21, and the other end is a stud end 22. Two first faces 23, two second faces 24, two third faces 25, and two fourth faces 26 are formed between the insertion end 21 and the stud end 22. Each of the first faces 23, each of the second faces 24, each of the third faces 25 and each of the fourth faces 26 are distributed in a ring array. A virtual central axis Y is defined to pass through the insertion end 21 along the axial direction of the socket post 20. The first faces 23 are opposite each other with the central axis Y as the center. Each of the second faces 24 is respectively located at one side of each of the first faces 23. The second faces 24 are opposite each other with the central axis as the center. Each of the third faces 25 is respectively located at the other side of each of the first faces 23. The third faces 25 are opposite each other with the central axis as the center. The fourth faces 26 are opposite each other with the central axis as the center. Each of the second faces 24 is respectively located at one side of each of the fourth faces 26. Each of the third faces 25 is respectively located at the other side of each of the fourth faces 26.

The socket post 20 goes laterally through the two through grooves 27. Each of the through grooves 27 is respectively located between the first faces 23, so that each of the first faces 23 and each of the second faces 24 can have relative elastic deformations. The number of the through groove 27 can be increased or decreased as needed, but there shall be at least one through groove 27. In the present embodiment, the through grooves 27 is arranged to be parallel to each other.

Each of the first faces 23 is protruded with a positioning convex portion 28 in the direction away from the central axis Y, so that each of the positioning convex portions 28 can enter the corresponding positioning dent 14 to relatively limit and position the sleeve 10.

A virtual first inscribed circle 31 is defined to be tangential to each of the first faces 23. The diameter of the first inscribed circle 31 is first diameter D1. The first diameter D1 matches the groove width W, so that each of the first faces 23 can respectively abut each of the corresponding groove walls 12. The first diameter D1 matching the groove width W means there is a fit tolerance between the first diameter D1 and the groove width W, so that, when each of the positioning convex portions 28 enters the corresponding positioning dent 14, each of the first faces 23 can respectively abut each of the corresponding groove walls 12.

A virtual second inscribed circle 32 is defined to be tangential to each of the second faces 24 and each of the third faces 25. The diameter of the second inscribed circle 32 is second diameter D2. The central axis Y passes through the centers of the first inscribed circle 31 and the second inscribed circle 32. The second diameter D2 is less than the first diameter D1. The distance between each of the second faces 24 and each of the third faces 25 is less than the groove width W, so that the socket post 20 can easily enter the casing groove 11. Thus, it is more convenient when using the sleeve 10 to sheathe the socket post 20.

Two convex ridges 29 are respectively formed between the adjacent first faces 23 and second faces 24. Each of the humps 29 is respectively protruded in the direction away from the central axis Y. Each of the humps 29 is respectively adjacent to each of the positioning convex portions 28, arranged in the direction parallel to the central axis Y. One end of each of the humps 29 is located between each of the positioning convex portions 28 and the insertion end 21, and the other end of each of the humps 29 is respectively extended toward the stud end 22.

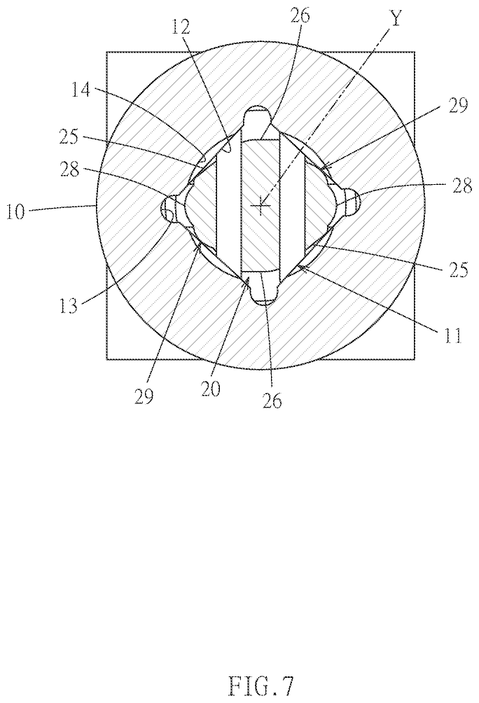

When the sleeve 10 is placed on the preferred embodiment, as shown in FIG. 7, the sleeve 10 sheathes the socket post 20 through the casing groove 11. The insertion end 21, the first face 23, the second face 24, the third face 25, and the fourth face 26 relatively enter the casing groove 11. Each of the second faces 24 and each of the third faces 25 respectively face each of the groove walls 12. Each of the first faces 23 and each of the fourth faces 26 respectively face each of the connecting edges 13. As the first diameter D1 matches the groove width W, and the second diameter D2 is less than the first diameter D1, the distance between each of the second faces 24 and each of the third faces 25 is less than the groove width W, the socket post 20 can relatively enter the casing groove 11 more easily to enhance convenience of operation.

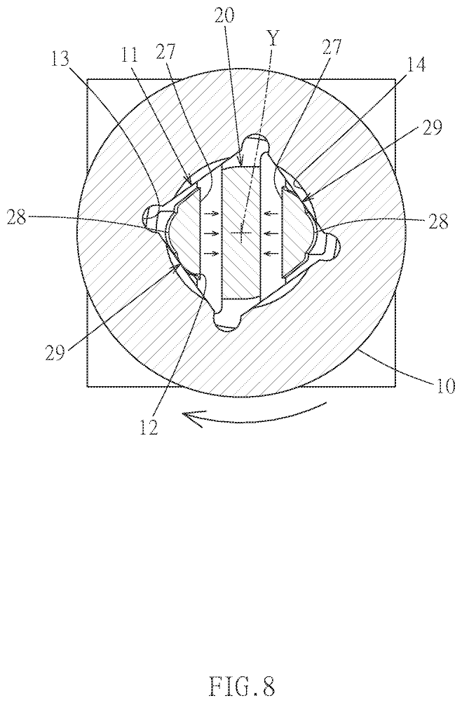

Referring to FIG. 8, when operating the sleeve 10 to rotate in relation to the socket post 20, each of the humps 29 respectively abuts on the opposite groove walls 12, and relatively slides along each of the groove walls 12. When the socket post 20 receives the pressure applied by the opposite groove walls 12 abutting each of the humps 29, each of the second faces 24 will have elastic deformation in the direction toward the central axis Y. When the sleeve 10 continues to rotate, each of the first faces 23 will be gradually turned to be opposite to the two groove walls 12, each of the positioning convex portions 28 will receive the pressure from each of the groove walls 12, and each of the first faces 23 will also have elastic deformation toward the direction in the direction toward the central axis Y.

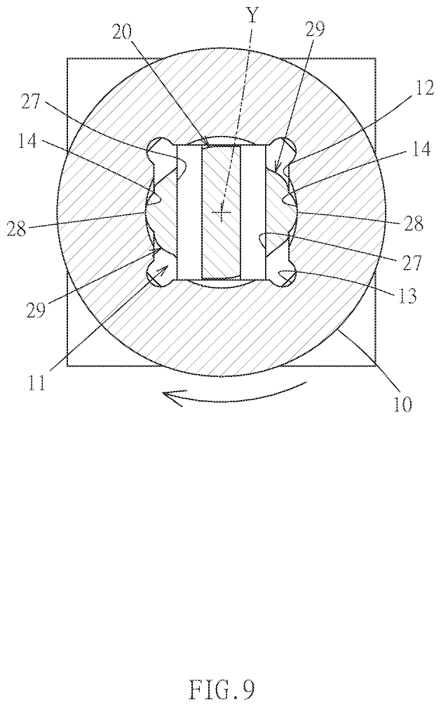

As shown in FIG. 9, along with the continuous rotation of the sleeve 10, when the two opposite positioning dents 14 are respectively opposite to each of the positioning convex portions 28, each of the positioning convex portions 28 will respectively enter each of the positioning dent 14 to complete the configuration of the sleeve 10. At this time, the sleeve 10 and the socket post 20 relatively limit each other, and the sleeve 10 is locked and positioned on the socket post 20.

As shown in FIG. 8 and FIG. 9, during the operation to rotate the sleeve 10 to make it locked and positioned on the socket post 20, each of the humps 29 respectively abuts the opposite groove walls 12, and slides relatively along each of the groove walls 12. The frictional force generated between each of the humps 29 and the opposite groove walls 12 will firstly increase and then decrease along with the rotation of the sleeve 10. Through the sleeve 10, the relative frictional force is reflected to the hand of the user clamping and turning the sleeve 10, providing a hand feel for the user operating the sleeve 10. By changing the size and shape of the hump 29, the strength of the hand feel can be changed.

Each of the humps 29 is respectively formed with a curved face 292 in the direction away from the central axis Y. A virtual first circumscribed circle 33 is defined to pass through the surface of each of the positioning convex portions 28. The first circumscribed circle 33 is tangential to each of the positioning convex portions 28. The diameter of the first circumscribed circle 33 is third diameter D3. A virtual second circumscribed circle 34 is defined to pass through the curved face 292 of each of the humps 29. The second circumscribed circle 34 is tangential to each of the curved faces 292. The diameter of the second circumscribed circle 34 is fourth diameter D4. The central axis Y passes through the centers of the first circumscribed circle 33 and the second circumscribed circle 34. The fourth diameter D4 is less than the third diameter D3, and the fourth diameter D4 is larger than the first diameter D1. Based on the relations between the first diameter D1, the third diameter D3 and the fourth diameter D4, during the course of rotation of the sleeve 10 fitted on the socket post 20, the relative friction can change stably.

The lateral width of each of the second faces 24 is respectively larger than the lateral width of each of the first faces 23, and each of the humps 29 is respectively further extended laterally to each of the adjacent first faces 23. Each of the humps 29 is respectively adjacent to each of the positioning convex portions 28.

A virtual transverse axis X is defined to pass through each of the positioning convex portions 28. The transverse axis X passes laterally through each of the through grooves 27 and intersects with the central axis Y uprightly, and the transverse axis X intersects uprightly with the direction pointing to the two sides of each of the through grooves 27.

An included angle θ is formed between each of the adjacent first faces 23 and second faces 24. The included angle θ ranges from 138° to 142°. The included angle θ depicted in the figure is 140°.

The plurality of socket posts 20 can be optionally configured on a base plate (not shown in the figure) or other similar components to form a varied embodiment not depicted in the figures. Multiple sleeves 10 of identical or different specifications can be configured on each of the socket posts 20, so as to provide a plurality of sleeves 10 for the convenience of collective storage and management.

I claim:

1. A one-piece tool latch structure, used for positioning and setting a sleeve, the sleeve has a square casing groove, the casing groove is extended at one end of the sleeve in the axial direction, to sheathe the insertion post of a ratchet tool, the periphery of the casing groove is formed with four groove walls and connecting edges in the shape of a concave arc respectively located between each of the groove walls, the distance between each of them to each of the opposite groove walls is defined as groove width W, each of the groove walls is respective configured with positioning dents in the shape of a concave arc;
the one-piece tool latch structure includes a socket post, wherein the socket post is made of an elastic material, one end of the socket post in the axial direction is an insertion end, and the other end is a stud end, two first faces, two second faces, two third faces and two fourth faces are formed between the insertion end and the stud end, each of the first faces, each of the second faces, each of the third faces and each of the fourth faces are distributed in a ring array, a virtual central axis Y is defined to go along the axial direction of the socket post and through the insertion end, each of the first faces are opposite each other with the central axis Y as the center, each of the second faces is respectively located at one side of each of the first faces, the second faces are respectively opposite each other with the central axis as the center, each of the third faces is respectively located at the other side of each of the first faces, the third faces are opposite each other with the central axis as the center, the fourth faces are opposite each other with the central axis as the center, each of the second faces is respectively located at one side of each of the fourth faces, each of the third faces is respectively located at the other side of each of the fourth faces;
the socket post goes through the through groove from the lateral direction, the through groove is located between each of the first faces, so that each of the first faces and each of the second faces can have relative elastic deformations;
each of the first faces is respectively protruded with a positioning convex portion in the direction away from the central axis Y, so that each of the positioning convex portions can enter the corresponding positioning dent to relatively limit and position the sleeve, a virtual first inscribed circle is defined to be tangential to each of the first faces, the diameter of the first inscribed circle is first diameter, the first diameter matches the groove width W, so that each of the first faces respectively adjacent to each of the corresponding groove walls, a virtual second inscribed circle is defined to be tangential to each of the second faces and each of the third faces, the diameter of the second inscribed circle is second diameter, the central axis Y passes through the centers of the first inscribed circle and the second inscribed circle, the second diameter is less than the first diameter, the distance between each of the second faces and the third faces is less than the groove width W, so that the socket post an easily enter the casing groove, and the sleeve can sheathe the socket post more conveniently;
two convex ridges are respectively formed between the adjacent first faces and the second faces, each of the humps is respectively protruded in the direction away from the central axis Y, each of the humps is respectively adjacent to each of the positioning convex portions, arranged in the direction parallel to the central axis Y, one end of each of the humps is located between each of the positioning convex portions and the insertion end, and the other end of each of the humps is respectively extended toward the stud end.

2. The one-piece tool latch structure defined in claim 1, wherein each of the humps is respectively formed with a curved face in the direction away from the central axis Y, a virtual first circumscribed circle is defined to pass through the surface of each of the positioning convex portions, the first circumscribed circle is tangential to each of the positioning convex portions, the diameter of the first circumscribed circle is third diameter, a virtual second circumscribed circle is defined to pass through the curved face of each of the humps, the second circumscribed circle is tangential to each of the curved faces, the diameter of the second circumscribed circle is fourth diameter, the central axis Y passes through the centers of the first circumscribed circle and the second circumscribed circle, the fourth diameter is less than the third diameter, and the fourth diameter is larger than the first diameter.

3. The one-piece tool latch structure defined in claim 1, wherein the lateral width of each of the second faces is respectively larger than the lateral width of each of the first faces, and each of the humps is respectively further extended laterally to each of the adjacent first faces, each of the humps is respectively adjacent to each of the positioning convex portions.

4. The one-piece tool latch structure defined in claim 2, wherein the lateral width of each of the second faces is respectively larger than the lateral width of each of the first faces, and each of the humps is respectively further extended laterally to each of the adjacent first faces, each of the humps is respectively adjacent to each of the positioning convex portions.

5. The one-piece tool latch structure defined in claim 1, wherein the socket post goes laterally through the through groove, the through grooves are parallel to each other, each of the through grooves is respectively located between the first faces, so that each of the first faces and each of the second faces can respectively have relative elastic deformations.

6. The one-piece tool latch structure defined in claim 1, wherein a virtual transverse axis X is defined to pass through each of the positioning convex portions, the transverse axis X passes through the through groove from the lateral direction and intersects with the central axis Y uprightly, and the directions of the transverse axis X and the through groove pointing to the sides intersect uprightly.

7. The one-piece tool latch structure defined in claim 1, wherein an included angle θ is formed between each of the adjacent first faces and second faces, and the included angle θ ranges from 138° to 142°.
